(19) United States
(12) Patent Application Publication
(10) Pub. No.: US 2025/0225689 A1
(43) Pub. Date: Jul. 10, 2025

(54) AVATAR FASHION DELIVERY

(71) Applicant: Snap Inc., Santa Monica, CA (US)

(72) Inventors: Stuart Matheson, Toronto (CA); Laura Smith, Toronto (CA); Allison Vaughan, Denver, CO (US); David Whyte, Toronto (CA)

(21) Appl. No.: 19/089,687

(22) Filed: Mar. 25, 2025

Related U.S. Application Data
(63) Continuation of application No. 18/050,826, filed on Oct. 28, 2022, now Pat. No. 12,288,273.

(51) Int. Cl. G06T 11/00; G06F 3/0482; G06Q 20/36; G06Q 30/0601; G06T 13/40; G06T 13/80; H04L 51/52

(52) U.S. Cl. CPC G06T 11/00; G06Q 20/3678; G06Q 30/0643; G06T 13/40; G06T 13/80; H04L 51/52; G06F 3/0482; G06T 2200/24; G06T 2210/16

(57) ABSTRACT

Aspects of the present disclosure involve a system comprising a computer-readable storage medium storing a program and a method for generating an avatar. The program and method perform operations comprising delivering, by a messaging server, a notification to a client device that identifies a fashion item for customizing an avatar of a user; causing the notification comprising the fashion item to be displayed on the client device; receiving, by the messaging server, a request from the client device to access the fashion item; determining that the request from the client device to access the fashion item has been received prior to expiration of a scarcity parameter of the fashion item; and enabling the client device to access the fashion item in response to determining that the request from the client device has been received prior to the expiration of the scarcity parameter of the fashion item.

### CLAIM OF PRIORITY

This application is a continuation of U.S. patent application Ser. No. 18/050,826, filed on Oct. 28, 2022, which is incorporated herein by reference in its entirety.

### TECHNICAL FIELD

The present disclosure relates generally to generating avatars using fashion items.

### BACKGROUND

Social network sites are some of the most popularly, if not the most popularly, visited sites on the Internet. Social networks provide a vast amount of information about users and their friends. Such information includes current status of users and their interests.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging client application, in accordance with some examples.

FIG. 3 is a diagrammatic representation of a data structure as maintained in a database, in accordance with some examples.

FIG. 4 is a diagrammatic representation of a message, in accordance with some examples.

FIG. 5 is a block diagram showing an example avatar fashion delivery system, according to some examples.

FIG. 6 is an illustration of example operations performed by the avatar fashion delivery system, according to some examples.

FIGS. 7-8 are illustrative inputs and outputs of the avatar fashion delivery system, according to example embodiments.

FIG. 9 is a block diagram illustrating a representative software architecture, which may be used in conjunction with various hardware architectures herein described, according to example embodiments.

FIG. 10 is a block diagram illustrating components of a machine able to read instructions from a machine-readable medium (e.g., a machine-readable storage medium) and perform any one or more of the methodologies discussed herein, according to example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments. It will be evident, however, to those skilled in the art, that embodiments may be practiced without these specific details. In general, well-known instruction instances, protocols, structures, and techniques are not necessarily shown in detail.

Typical systems allow users to customize their avatars in many different ways. The users can apply certain fashion items (e.g., clothing, garments, outfits) and accessories to the avatars to represent their identity and/or interests. Users are constantly seeking new ways to customize their avatar to enable others to recognize and connect with each other. The customizations offered by the typical systems are usually of generic form and are standardized across all of the users of the system. This prevents users from having their own unique style and taste represented by the avatars which detracts from the overall use and enjoyment of the system.

Also, because the customizations are standardized across the system, it becomes difficult for users to create avatars that stand out from other avatars in unique ways. Some systems allow users to access third-party applications to search for and customize their avatars. But such systems may not be compatible with the messaging systems and involve a great deal of time and expense navigating through multiple interfaces and pages of information to find a unique customization for the avatar. The lack of visual appeal or connection to a specific user and the need to manually navigate through multiple pages of information, makes such systems less attractive and less intuitive to use which increases their overall complexity.

The disclosed embodiments improve the efficiency of using the electronic device by enabling users to incorporate unique and scarce fashion items into their avatars for use in communicating with users in a messaging application. Specifically, according to some embodiments, various features or customizations of the one or more avatars are time and/or quantity limited or restricted and/or are delivered and made available to a select subset of the population. Users who receive the customizations (e.g., fashion items for the avatars) and request to have such customizations enabled within the time and/or quantity restrictions are provided with access to the customizations. This provides such users unique ways to add customizations to their avatars in unique environments and situations which increases the overall appeal and enjoyment of the system.

According to the disclosed examples, the disclosed techniques deliver, by a messaging server, a notification to a client device that identifies a fashion item for customizing an avatar of a user. The disclosed techniques cause the notification including the fashion item to be displayed on the client device. The disclosed techniques receive, by the messaging server, a request from the client device to access the fashion item and determine whether the request from the client device to access the fashion item has been received prior to expiration of a scarcity parameter of the fashion item. The disclosed techniques enable the client device to access the fashion item in response to determining that the request from the client device has been received prior to the expiration of the scarcity parameter of the fashion item. As referred to herein, the phrase “fashion item” or “fashion” includes any garment, costume, costume effect, outfit, or article of clothing or accessory that can be placed on or included in an avatar, such as jewelry, makeup, a dress, pants, shorts, t-shirt, watch, shoes, socks, rings, hair accessory, hat, earrings, chains, and so forth.

By presenting to a user such time-restricted and/or quantity-restricted fashion items to use to customize the avatar, the user and the user's friends are provided with a simple and intuitive interface for generating avatars that represent their identities and/or interest in unique ways. Namely, with minimal user input, unique customizations can be provided to a user. This way, users do not need to navigate through a multitude of different pages of information to add unique customizations to their avatars. This improves the overall efficiencies of the computing device and reduces complexities in using the messaging application.

### Networked Computing Environment

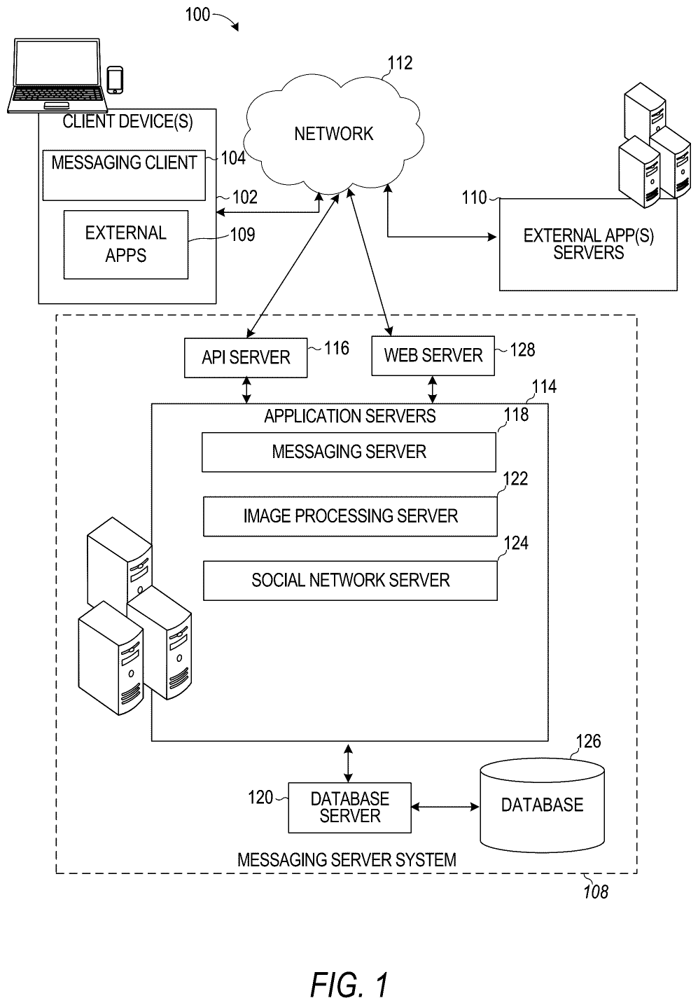

FIG. 1 is a block diagram showing an example messaging system 100 for exchanging data (e.g., messages and associated content) over a network. The messaging system 100 includes multiple instances of a client device 102, each of which hosts a number of applications, including a messaging client 104 and other external applications 109 (e.g., third-party applications). Each messaging client 104 is communicatively coupled to other instances of the messaging client 104 (e.g., hosted on respective other client devices 102), a messaging server system 108 and external app(s) servers 110 via a network 112 (e.g., the Internet). A messaging client 104 can also communicate with locally-hosted third-party applications (also referred to as “external applications” and “external apps”) 109 using Application Program Interfaces (APIs).

The client device 102 may operate as a standalone device or may be coupled (e.g., networked) to other machines. In a networked deployment, the client device 102 may operate in the capacity of a server machine or a client machine in a server-client network environment, or as a peer machine in a peer-to-peer (or distributed) network environment. The client device 102 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the disclosed operations. Further, while only a single client device 102 is illustrated, the term “client device” shall also be taken to include a collection of machines that individually or jointly execute the disclosed operations.

In some examples, the client device 102 can include AR glasses or an AR headset in which virtual content is displayed within lenses of the glasses while a user views a real-world environment through the lenses. For example, an image can be presented on a transparent display that allows a user to simultaneously view content presented on the display and real-world objects.

A messaging client 104 is able to communicate and exchange data with other messaging clients 104 and with the messaging server system 108 via the network 112. The data exchanged between messaging clients 104, and between a messaging client 104 and the messaging server system 108, includes functions (e.g., commands to invoke functions) as well as payload data (e.g., text, audio, video or other multimedia data).

The messaging server system 108 provides server-side functionality via the network 112 to a particular messaging client 104. While certain functions of the messaging system 100 are described herein as being performed by either a messaging client 104 or by the messaging server system 108, the location of certain functionality either within the messaging client 104 or the messaging server system 108 may be a design choice. For example, it may be technically preferable to initially deploy certain technology and functionality within the messaging server system 108 but to later migrate this technology and functionality to the messaging client 104 where a client device 102 has sufficient processing capacity.

The messaging server system 108 supports various services and operations that are provided to the messaging client 104. Such operations include transmitting data to, receiving data from, and processing data generated by the messaging client 104. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 104.

Turning now specifically to the messaging server system 108, an API server 116 is coupled to, and provides a programmatic interface to, application servers 114. The application servers 114 are communicatively coupled to a database server 120, which facilitates access to a database 126 that stores data associated with messages processed by the application servers 114. Similarly, a web server 128 is coupled to the application servers 114, and provides web-based interfaces to the application servers 114. To this end, the web server 128 processes incoming network requests over the Hypertext Transfer Protocol (HTTP) and several other related protocols.

The API server 116 receives and transmits message data (e.g., commands and message payloads) between the client device 102 and the application servers 114. Specifically, the API server 116 provides a set of interfaces (e.g., routines and protocols) that can be called or queried by the messaging client 104 in order to invoke functionality of the application servers 114. The API server 116 exposes various functions supported by the application servers 114, including account registration, login functionality, the sending of messages, via the application servers 114, from a particular messaging client 104 to another messaging client 104, the sending of media files (e.g., images or video) from a messaging client 104 to a messaging server 118, and for possible access by another messaging client 104, the settings of a collection of media data (e.g., story), the retrieval of a list of friends of a user of a client device 102, the retrieval of such collections, the retrieval of messages and content, the addition and deletion of entities (e.g., friends) to an entity graph (e.g., a social graph), the location of friends within a social graph, and opening an application event (e.g., relating to the messaging client 104).

The application servers 114 host a number of server applications and subsystems, including for example a messaging server 118, an image processing server 122, and a social network server 124. The messaging server 118 implements a number of message processing technologies and functions, particularly related to the aggregation and other processing of content (e.g., textual and multimedia content) included in messages received from multiple instances of the messaging client 104. As will be described in further detail, the text and media content from multiple sources may be aggregated into collections of content (e.g., called stories or galleries). These collections are then made available to the messaging client 104. Other processor-and memory-intensive processing of data may also be performed server-side by the messaging server 118, in view of the hardware requirements for such processing.

The application servers 114 also include an image processing server 122 that is dedicated to performing various image processing operations, typically with respect to images or video within the payload of a message sent from or received at the messaging server 118.

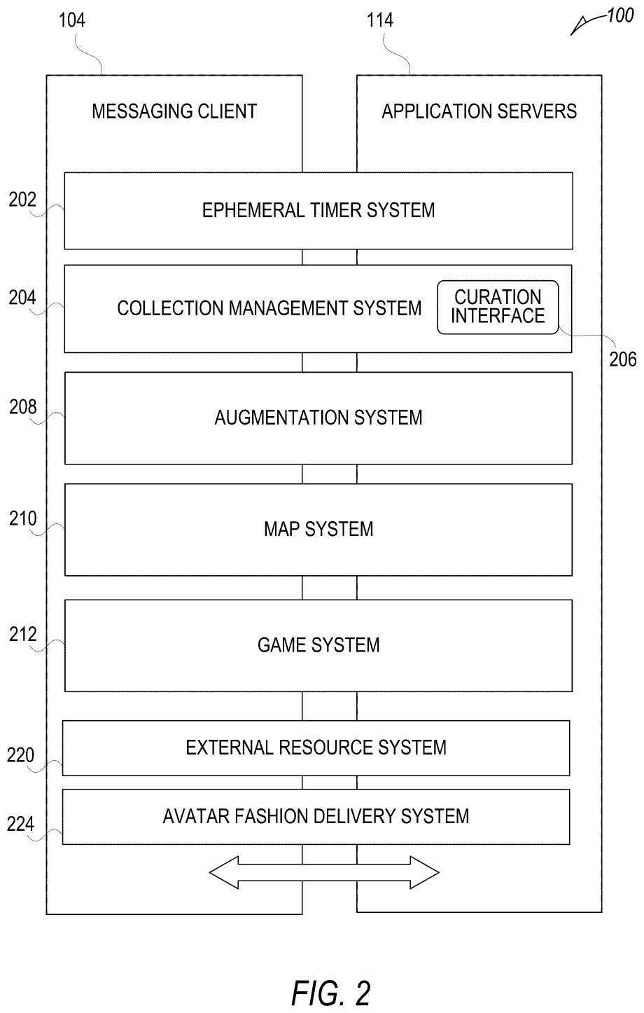

Image processing server 122 is used to implement scan functionality of the augmentation system 208 (shown in FIG. 2). Scan functionality includes activating and providing one or more augmented reality experiences on a client device 102 when an image is captured by the client device 102. Specifically, the messaging client 104 on the client device 102 can be used to activate a camera. The camera displays one or more real-time images or a video to a user along with one or more icons or identifiers of one or more augmented reality experiences. The user can select a given one of the identifiers to launch the corresponding augmented reality experience or perform a desired image modification.

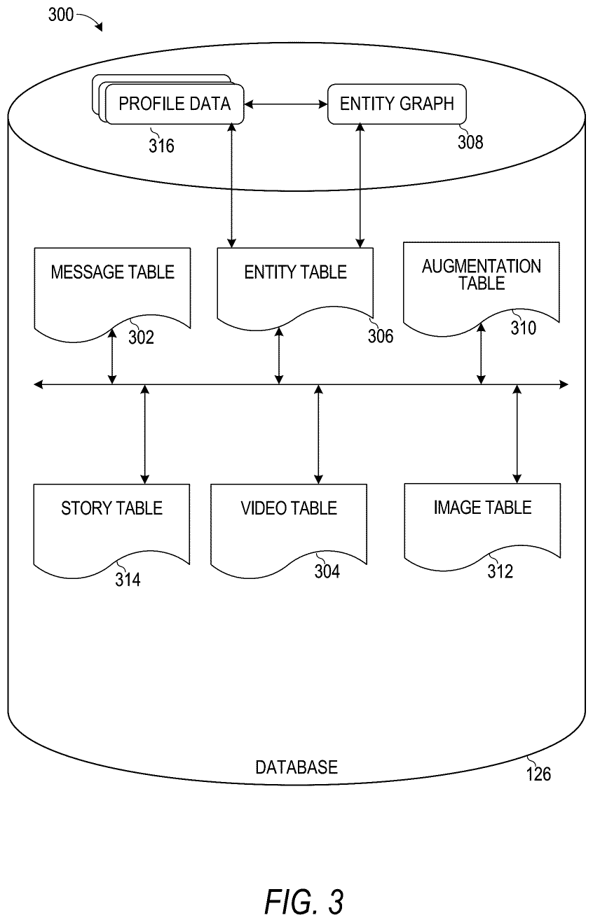

The social network server 124 supports various social networking functions and services and makes these functions and services available to the messaging server 118. To this end, the social network server 124 maintains and accesses an entity graph 308 (as shown in FIG. 3) within the database 126. Examples of functions and services supported by the social network server 124 include the identification of other users of the messaging system 100 with which a particular user has relationships or is “following,” and also the identification of other entities and interests of a particular user.

Returning to the messaging client 104, features and functions of an external resource (e.g., an external application 109 or applet) are made available to a user via an interface of the messaging client 104. The messaging client 104 receives a user selection of an option to launch or access features of an external resource (e.g., a third-party resource), such as external apps 109. The external resource may be a third-party application (external apps 109) installed on the client device 102 (e.g., a “native app”), or a small-scale version of the third-party application (e.g., an “applet”) that is hosted on the client device 102 or remote of the client device 102 (e.g., on external resource or app(s) servers 110). The small-scale version of the third-party application includes a subset of features and functions of the third-party application (e.g., the full-scale, native version of the third-party standalone application) and is implemented using a markup-language document. In one example, the small-scale version of the third-party application (e.g., an “applet”) is a web-based, markup-language version of the third-party application and is embedded in the messaging client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource (e.g., external app 109), the messaging client 104 determines whether the selected external resource is a web-based external resource or a locally-installed external application. In some cases, external applications 109 that are locally installed on the client device 102 can be launched independently of and separately from the messaging client 104, such as by selecting an icon, corresponding to the external application 109, on a home screen of the client device 102. Small-scale versions of such external applications can be launched or accessed via the messaging client 104 and, in some examples, no or limited portions of the small-scale external application can be accessed outside of the messaging client 104. The small-scale external application can be launched by the messaging client 104 receiving, from an external app(s) server 110, a markup-language document associated with the small-scale external application and processing such a document.

In response to determining that the external resource is a locally-installed external application 109, the messaging client 104 instructs the client device 102 to launch the external application 109 by executing locally-stored code corresponding to the external application 109. In response to determining that the external resource is a web-based resource, the messaging client 104 communicates with the external app(s) servers 110 to obtain a markup-language document corresponding to the selected resource. The messaging client 104 then processes the obtained markup-language document to present the web-based external resource within a user interface of the messaging client 104.

The messaging client 104 can notify a user of the client device 102, or other users related to such a user (e.g., “friends”), of activity taking place in one or more external resources. For example, the messaging client 104 can provide participants in a conversation (e.g., a chat session) in the messaging client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using a respective messaging client 104, with the ability to share an item, status, state, or location in an external resource with one or more members of a group of users into a chat session. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the messaging client 104. The external resource can selectively include different media items in the responses, based on a current context of the external resource.

The messaging client 104 can present a list of the available external resources (e.g., third-party or external applications 109 or applets) to a user to launch or access a given external resource. This list can be presented in a context-sensitive menu. For example, the icons representing different ones of the external applications 109 (or applets) can vary based on how the menu is launched by the user (e.g., from a conversation interface or from a non-conversation interface).

### System Architecture

FIG. 2 is a block diagram illustrating further details regarding the messaging system 100, according to some examples. Specifically, the messaging system 100 is shown to comprise the messaging client 104 and the application servers 114. The messaging system 100 embodies a number of subsystems, which are supported on the client side by the messaging client 104 and on the sever side by the application servers 114. These subsystems include, for example, an ephemeral timer system 202, a collection management system 204, an augmentation system 208, a map system 210, a game system 212, and an external resource system 220.

The ephemeral timer system 202 is responsible for enforcing the temporary or time-limited access to content by the messaging client 104 and the messaging server 118. The ephemeral timer system 202 incorporates a number of timers that, based on duration and display parameters associated with a message, or collection of messages (e.g., a story), selectively enable access (e.g., for presentation and display) to messages and associated content via the messaging client 104. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 104.

The collection management system 204 also includes a curation interface 206 that allows a collection manager to manage and curate a particular collection of content. For example, the curation interface 206 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 208 provides various functions that enable a user to augment (e.g., annotate or otherwise modify or edit) media content associated with a message. For example, the augmentation system 208 provides functions related to the generation and publishing of media overlays for messages processed by the messaging system 100. The augmentation system 208 operatively supplies a media overlay or augmentation (e.g., an image filter) to the messaging client 104 based on a geolocation of the client device 102. In another example, the augmentation system 208 operatively supplies a media overlay to the messaging client 104 based on other information, such as social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the media overlay may include text, a graphical element, or image that can be overlaid on top of a photograph taken by the client device 102. In another example, the media overlay includes an identification of a location overlay (e.g., Venice beach), a name of a live event, or a name of a merchant overlay (e.g., Beach Coffee House). In another example, the augmentation system 208 uses the geolocation of the client device 102 to identify a media overlay that includes the name of a merchant at the geolocation of the client device 102. The media overlay may include other indicia associated with the merchant. The media overlays may be stored in the database 126 and accessed through the database server 120.

In some examples, the augmentation system 208 provides a user-based publication platform that enables users to select a geolocation on a map and upload content associated with the selected geolocation. The user may also specify circumstances under which a particular media overlay should be offered to other users. The augmentation system 208 generates a media overlay that includes the uploaded content and associates the uploaded content with the selected geolocation.

In other examples, the augmentation system 208 provides a merchant-based publication platform that enables merchants to select a particular media overlay associated with a geolocation via a bidding process. For example, the augmentation system 208 associates the media overlay of the highest bidding merchant with a corresponding geolocation for a predefined amount of time. The augmentation system 208 communicates with the image processing server 122 to obtain augmented reality experiences and presents identifiers of such experiences in one or more user interfaces (e.g., as icons over a real-time image or video or as thumbnails or icons in interfaces dedicated for presented identifiers of augmented reality experiences). Once an augmented reality experience is selected, one or more images, videos, or augmented reality graphical elements are retrieved and presented as an overlay on top of the images or video captured by the client device 102. In some cases, the camera is switched to a front-facing view (e.g., the front-facing camera of the client device 102 is activated in response to activation of a particular augmented reality experience) and the images from the front-facing camera of the client device 102 start being displayed on the client device 102 instead of the rear-facing camera of the client device 102. The one or more images, videos, or augmented reality graphical elements are retrieved and presented as an overlay on top of the images that are captured and displayed by the front-facing camera of the client device 102.

In other examples, the augmentation system 208 is able to communicate and exchange data with another augmentation system 208 on another client device 102 and with the server via the network 112. The data exchanged can include a session identifier that identifies the shared AR session, a transformation between a first client device 102 and a second client device 102 (e.g., a plurality of client devices 102 include the first and second devices) that is used to align the shared AR session to a common point of origin, a common coordinate frame, functions (e.g., commands to invoke functions) as well as other payload data (e.g., text, audio, video or other multimedia data).

The augmentation system 208 sends the transformation to the second client device 102 so that the second client device 102 can adjust the AR coordinate system based on the transformation. In this way, the first and second client devices 102 synch up their coordinate systems and frames for displaying content in the AR session. Specifically, the augmentation system 208 computes the point of origin of the second client device 102 in the coordinate system of the first client device 102. The augmentation system 208 can then determine an offset in the coordinate system of the second client device 102 based on the position of the point of origin from the perspective of the second client device 102 in the coordinate system of the second client device 102. This offset is used to generate the transformation so that the second client device 102 generates AR content according to a common coordinate system or frame as the first client device 102.

The augmentation system 208 can communicate with the client device 102 to establish individual or shared AR sessions. The augmentation system 208 can also be coupled to the messaging server 118 to establish an electronic group communication session (e.g., group chat, instant messaging) for the client devices 102 in a shared AR session. The electronic group communication session can be associated with a session identifier provided by the client devices 102 to gain access to the electronic group communication session and to the shared AR session. In one example, the client devices 102 first gain access to the electronic group communication session and then obtain the session identifier in the electronic group communication session that allows the client devices 102 to access to the shared AR session. In some examples, the client devices 102 are able to access the shared AR session without aid or communication with the augmentation system 208 in the application servers 114.

The map system 210 provides various geographic location functions, and supports the presentation of map-based media content and messages by the messaging client 104. For example, the map system 210 enables the display of user icons or avatars (e.g., stored in profile data 316) on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 104. A user can furthermore share his or her location and status information (e.g., using an appropriate status avatar) with other users of the messaging system 100 via the messaging client 104, with this location and status information being similarly displayed within the context of a map interface of the messaging client 104 to selected users.

The game system 212 provides various gaming functions within the context of the messaging client 104. The messaging client 104 provides a game interface providing a list of available games (e.g., web-based games or web-based applications) that can be launched by a user within the context of the messaging client 104, and played with other users of the messaging system 100. The messaging system 100 further enables a particular user to invite other users to participate in the play of a specific game, by issuing invitations to such other users from the messaging client 104. The messaging client 104 also supports both voice and text messaging (e.g., chats) within the context of gameplay, provides a leaderboard for the games, and also supports the provision of in-game rewards (e.g., coins and items).

The external resource system 220 provides an interface for the messaging client 104 to communicate with external app(s) servers 110 to launch or access external resources. Each external resource (apps) server 110 hosts, for example, a markup language (e.g., HTML5) based application or small-scale version of an external application (e.g., game, utility, payment, or ride-sharing application that is external to the messaging client 104). The messaging client 104 may launch a web-based resource (e.g., application) by accessing the HTML5 file from the external resource (apps) servers 110 associated with the web-based resource. In certain examples, applications hosted by external resource servers 110 are programmed in JavaScript leveraging a Software Development Kit (SDK) provided by the messaging server 118. The SDK includes APIs with functions that can be called or invoked by the web-based application. In certain examples, the messaging server 118 includes a JavaScript library that provides a given third-party resource access to certain user data of the messaging client 104. HTML5 is used as an example technology for programming games, but applications and resources programmed based on other technologies can be used.

In order to integrate the functions of the SDK into the web-based resource, the SDK is downloaded by an external resource (apps) server 110 from the messaging server 118 or is otherwise received by the external resource (apps) server 110. Once downloaded or received, the SDK is included as part of the application code of a web-based external resource. The code of the web-based resource can then call or invoke certain functions of the SDK to integrate features of the messaging client 104 into the web-based resource.

The SDK stored on the messaging server 118 effectively provides the bridge between an external resource (e.g., third-party or external applications 109 or applets and the messaging client 104). This provides the user with a seamless experience of communicating with other users on the messaging client 104, while also preserving the look and feel of the messaging client 104. To bridge communications between an external resource and a messaging client 104, in certain examples, the SDK facilitates communication between external resource servers 110 and the messaging client 104. In certain examples, a WebViewJavaScriptBridge running on a client device 102 establishes two one-way communication channels between an external resource and the messaging client 104. Messages are sent between the external resource and the messaging client 104 via these communication channels asynchronously. Each SDK function invocation is sent as a message and callback. Each SDK function is implemented by constructing a unique callback identifier and sending a message with that callback identifier.

By using the SDK, not all information from the messaging client 104 is shared with external resource servers 110. The SDK limits which information is shared based on the needs of the external resource. In certain examples, each external resource server 110 provides an HTML5 file corresponding to the web-based external resource to the messaging server 118. The messaging server 118 can add a visual representation (such as a box art or other graphic) of the web-based external resource in the messaging client 104. Once the user selects the visual representation or instructs the messaging client 104 through a GUI of the messaging client 104 to access features of the web-based external resource, the messaging client 104 obtains the HTML5 file and instantiates the resources necessary to access the features of the web-based external resource.

The messaging client 104 presents a graphical user interface (e.g., a landing page or title screen) for an external resource. During, before, or after presenting the landing page or title screen, the messaging client 104 determines whether the launched external resource has been previously authorized to access user data of the messaging client 104. In response to determining that the launched external resource has been previously authorized to access user data of the messaging client 104, the messaging client 104 presents another graphical user interface of the external resource that includes functions and features of the external resource. In response to determining that the launched external resource has not been previously authorized to access user data of the messaging client 104, after a threshold period of time (e.g., 3 seconds) of displaying the landing page or title screen of the external resource, the messaging client 104 slides up (e.g., animates a menu as surfacing from a bottom of the screen to a middle of or other portion of the screen) a menu for authorizing the external resource to access the user data. The menu identifies the type of user data that the external resource will be authorized to use. In response to receiving a user selection of an accept option, the messaging client 104 adds the external resource to a list of authorized external resources and allows the external resource to access user data from the messaging client 104. In some examples, the external resource is authorized by the messaging client 104 to access the user data in accordance with an OAuth 2 framework.

The messaging client 104 controls the type of user data that is shared with external resources based on the type of external resource being authorized. For example, external resources that include full-scale external applications (e.g., a third-party or external application 109) are provided with access to a first type of user data (e.g., only two-dimensional avatars of users with or without different avatar characteristics). As another example, external resources that include small-scale versions of external applications (e.g., web-based versions of third-party applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An avatar fashion delivery system 224 allows a user to customize a look and feel of an avatar, such as by adding one or more fashion items to the avatar. The avatar fashion delivery system 224 can provide a virtual closet interface to the user to select between various fashion items. In response to receiving a selection of a particular fashion item, the particular fashion item is placed on top of the avatar. The avatar with the particular fashion item can then be shared with one or more other users, such as friends on a messaging client 104.

In some examples, the avatar fashion delivery system 224 can receive or deliver to a user a notification about a scarce fashion item. The scarce fashion item can be available to selection to add to the virtual closet and/or to augment the avatar only during a specified time period and/or while a remaining quantity is non-zero. After a number of users corresponding to the remaining quantity have selected an option to add the scarce fashion item to their virtual closets and/or modify their respective avatars, the scarce fashion item is no longer available for selection by the user. In some cases, after the specified time period elapses, the scarce fashion item is no longer available for selection by the user.

Specifically, the avatar fashion delivery system 224 delivers, by a messaging server, a notification to a client device 102 that identifies a fashion item for customizing an avatar of a user. The avatar fashion delivery system 224 causes the notification including the fashion item to be displayed on the client device 102 and receives a request from the client device 102 to access the fashion item. The avatar fashion delivery system 224 determines that the request from the client device 102 to access the fashion item has been received prior to expiration of a scarcity parameter (e.g., a time period or remaining quantity) of the fashion item and enables the client device 102 to access the fashion item in response to determining that the request from the client device 102 has been received prior to the expiration of the scarcity parameter of the fashion item.

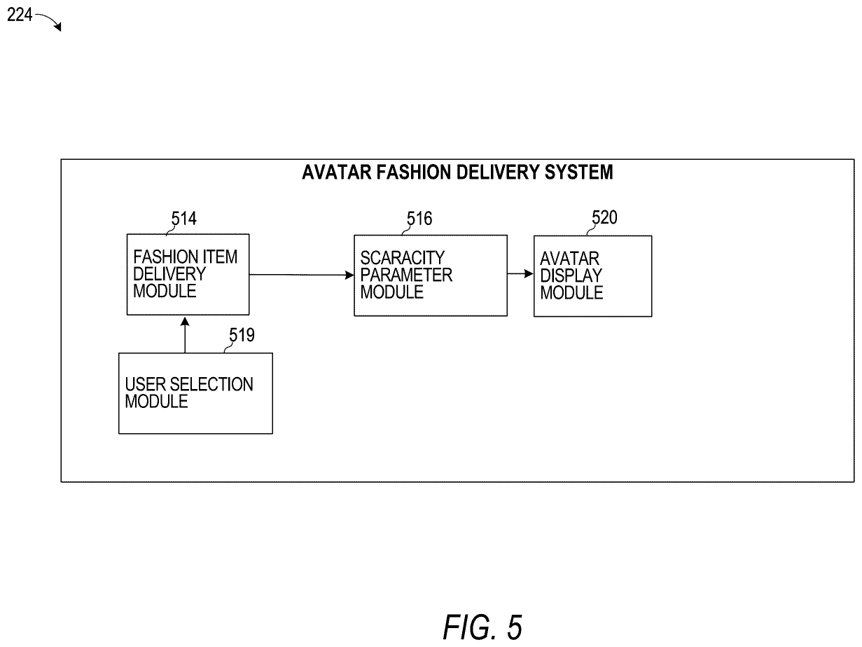

An illustrative implementation of the avatar fashion delivery system 224 is shown and described in connection with FIG. 5 below.

### Data Architecture

FIG. 3 is a schematic diagram illustrating data structures 300, which may be stored in the database 126 of the messaging server system 108, according to certain examples. While the content of the database 126 is shown to comprise a number of tables, it will be appreciated that the data could be stored in other types of data structures (e.g., as an object-oriented database).

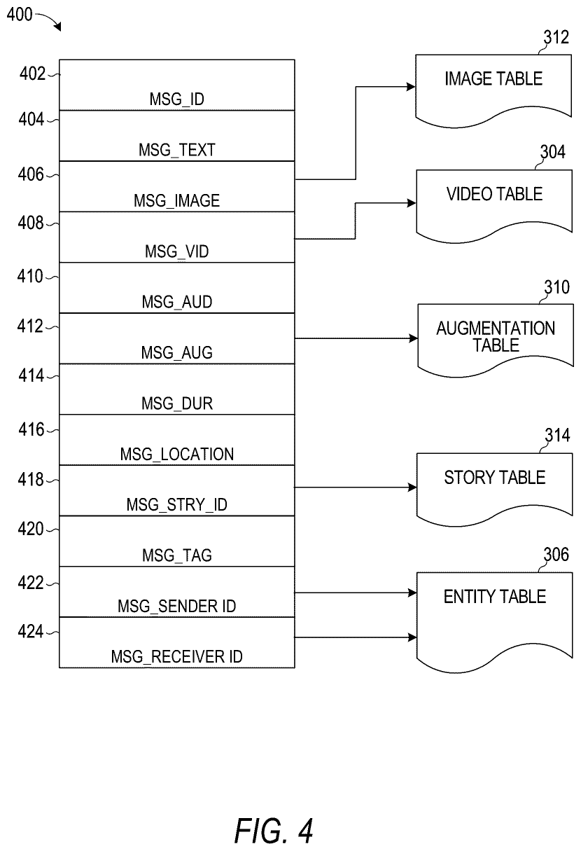

The database 126 includes message data stored within a message table 302. This message data includes, for any particular one message, at least message sender data, message recipient (or receiver) data, and a payload. Further details regarding information that may be included in a message, and included within the message data stored in the message table 302, are described below with reference to FIG. 4.

An entity table 306 stores entity data, and is linked (e.g., referentially) to an entity graph 308 and profile data 316. Entities for which records are maintained within the entity table 306 may include individuals, corporate entities, organizations, objects, places, events, and so forth. Regardless of entity type, any entity regarding which the messaging server system 108 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization) interest-based or activity-based, merely for example.

The profile data 316 stores multiple types of profile data about a particular entity. The profile data 316 may be selectively used and presented to other users of the messaging system 100, based on privacy settings specified by a particular entity. Where the entity is an individual, the profile data 316 includes, for example, a user name, telephone number, address, settings (e.g., notification and privacy settings), as well as a user-selected avatar representation (or collection of such avatar representations) and an associated virtual closet that includes one or more virtual fashion items that can be placed on the avatar. A particular user may then selectively include one or more of these avatar representations within the content of messages communicated via the messaging system 100, and on map interfaces displayed by messaging clients 104 to other users. The collection of avatar representations may include “status avatars,” which present a graphical representation of a status or activity that the user may select to communicate at a particular time.

Where the entity is a group, the profile data 316 for the group may similarly include one or more avatar representations associated with the group, in addition to the group name, members, and various settings (e.g., notifications) for the relevant group.

The database 126 also stores augmentation data, such as overlays or filters, in an augmentation table 310. The augmentation data is associated with and applied to videos (for which data is stored in a video table 304) and images (for which data is stored in an image table 312).

The database 126 can also store data pertaining to individual and shared AR sessions. This data can include data communicated between an AR session client controller of a first client device 102 and another AR session client controller of a second client device 102, and data communicated between the AR session client controller and the augmentation system 208. Data can include data used to establish the common coordinate frame of the shared AR scene, the transformation between the devices, the session identifier, images depicting a body, skeletal joint positions, wrist joint positions, feet, and so forth.

Filters, in one example, are overlays that are displayed as overlaid on an image or video during presentation to a recipient user. Filters may be of various types, including user-selected filters from a set of filters presented to a sending user by the messaging client 104 when the sending user is composing a message. Other types of filters include geolocation filters (also known as geo-filters), which may be presented to a sending user based on geographic location. For example, geolocation filters specific to a neighborhood or special location may be presented within a user interface by the messaging client 104, based on geolocation information determined by a Global Positioning System (GPS) unit of the client device 102.

Another type of filter is a data filter, which may be selectively presented to a sending user by the messaging client 104, based on other inputs or information gathered by the client device 102 during the message creation process. Examples of data filters include current temperature at a specific location, a current speed at which a sending user is traveling, battery life for a client device 102, or the current time.

Other augmentation data that may be stored within the image table 312 includes augmented reality content items (e.g., corresponding to applying augmented reality experiences). An augmented reality content item or augmented reality item may be a real-time special effect and sound that may be added to an image or a video.

As described above, augmentation data includes augmented reality content items, overlays, image transformations, AR images, and similar terms that refer to modifications that may be applied to image data (e.g., videos or images). This includes real-time modifications, which modify an image as it is captured using device sensors (e.g., one or multiple cameras) of a client device 102 and then displayed on a screen of the client device 102 with the modifications. This also includes modifications to stored content, such as video clips in a gallery that may be modified. For example, in a client device 102 with access to multiple augmented reality content items, a user can use a single video clip with multiple augmented reality content items to see how the different augmented reality content items will modify the stored clip. For example, multiple augmented reality content items that apply different pseudorandom movement models can be applied to the same content by selecting different augmented reality content items for the content. Similarly, real-time video capture may be used with an illustrated modification to show how video images currently being captured by sensors of a client device 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In other examples, tracking of points on an object may be used to place an image or texture (which may be two dimensional or three dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each of the at least one element of the object. This mesh is used in the following stage of tracking the elements of the object in the video stream. In the process of tracking, the mentioned mesh for each element is aligned with a position of each element. Then, additional points are generated on the mesh. A set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such a method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In some examples, a search is started for landmarks from the mean shape aligned to the position and size of the face determined by a global face detector. Such a search then repeats the steps of suggesting a tentative shape by adjusting the locations of shape points by template matching of the image texture around each point and then conforming the tentative shape to a global shape model until convergence occurs. In some systems, individual template matches are unreliable, and the shape model pools the results of the weak template matches to form a stronger overall classifier. The entire search is repeated at each level in an image pyramid, from coarse to fine resolution.

A transformation system can capture an image or video stream on a client device (e.g., the client device 102) and perform complex image manipulations locally on the client device 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 102.

In some examples, a computer animation model to transform image data can be used by a system where a user may capture an image or video stream of the user (e.g., a selfie) using a client device 102 having a neural network operating as part of a messaging client 104 operating on the client device 102. The transformation system operating within the messaging client 104 determines the presence of a face within the image or video stream and provides modification icons associated with a computer animation model to transform image data, or the computer animation model can be present as associated with an interface described herein. The modification icons include changes that may be the basis for modifying the user's face within the image or video stream as part of the modification operation. Once a modification icon is selected, the transformation system initiates a process to convert the image of the user to reflect the selected modification icon (e.g., generate a smiling face on the user). A modified image or video stream may be presented in a graphical user interface displayed on the client device 102 as soon as the image or video stream is captured, and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transformation system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 314 stores data regarding collections of messages and associated image, video, or audio data, which are compiled into a collection (e.g., a story or a gallery). The creation of a particular collection may be initiated by a particular user (e.g., each user for which a record is maintained in the entity table 306). A user may create a “personal story” in the form of a collection of content that has been created and sent/broadcast by that user. To this end, the user interface of the messaging client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the messaging client 104, to contribute content to a particular live story. The live story may be identified to the user by the messaging client 104, based on his or her location. The end result is a “live story” told from a community perspective.

A further type of content collection is known as a “location story,” which enables a user whose client device 102 is located within a specific geographic location (e.g., on a college or university campus) to contribute to a particular collection. In some examples, a contribution to a location story may require a second degree of authentication to verify that the end user belongs to a specific organization or other entity (e.g., is a student on the university campus).

As mentioned above, the video table 304 stores video data that, in one example, is associated with messages for which records are maintained within the message table 302. Similarly, the image table 312 stores image data associated with messages for which message data is stored in the entity table 306. The entity table 306 may associate various augmentations from the augmentation table 310 with various images and videos stored in the image table 312 and the video table 304.

The data structures 300 can also store training data for training one or more machine learning techniques (models) to generate 2D bounding boxes. The training data can include a plurality of training videos and corresponding ground truth bounding boxes. The images and videos can include a mix of all sorts of real-world objects that can appear in different real-world environments, such as different rooms in a home or household. The one or more machine learning techniques or models can be trained to extract features of a received input image or video and establish a relationship between the extracted features and a 2D bounding box of real-world objects depicted in the image or video. Once trained, the machine learning technique can receive a new image or video and can estimate a 2D bounding box for the newly received image or video.

### Data Communications Architecture

FIG. 4 is a schematic diagram illustrating a structure of a message 400, according to some examples, generated by a messaging client 104 for communication to a further messaging client 104 or the messaging server 118. The content of a particular message 400 is used to populate the message table 302 stored within the database 126, accessible by the messaging server 118. Similarly, the content of a message 400 is stored in memory as “in-transit” or “in-flight” data of the client device 102 or the application servers 114. A message 400 is shown to include the following example components:
message identifier 402: a unique identifier that identifies the message 400.
message text payload 404: text, to be generated by a user via a user interface of the client device 102, and that is included in the message 400.
message image payload 406: image data, captured by a camera component of a client device 102 or retrieved from a memory component of a client device 102, and that is included in the message 400. Image data for a sent or received message 400 may be stored in the image table 312.
message video payload 408: video data, captured by a camera component or retrieved from a memory component of the client device 102, and that is included in the message 400. Video data for a sent or received message 400 may be stored in the video table 304.
message audio payload 410: audio data, captured by a microphone or retrieved from a memory component of the client device 102, and that is included in the message 400.
message augmentation data 412: augmentation data (e.g., filters, stickers, or other annotations or enhancements) that represents augmentations to be applied to message image payload 406, message video payload 408, or message audio payload 410 of the message 400. Augmentation data 412 for a sent or received message 400 may be stored in the augmentation table 310.
message duration parameter 414: parameter value indicating, in seconds, the amount of time for which content of the message (e.g., the message image payload 406, message video payload 408, message audio payload 410) is to be presented or made accessible to a user via the messaging client 104.
message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
message story identifier 418: identifier values identifying one or more content collections (e.g., “stories” identified in the story table 314) with which a particular content item in the message image payload 406 of the message 400 is associated. For example, multiple images within the message image payload 406 may each be associated with multiple content collections using identifier values.
message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
message sender identifier 422: an identifier (e.g., a messaging system identifier, email address, or device identifier) indicative of a user of the client device 102 on which the message 400 was generated and from which the message 400 was sent.
message receiver identifier 424: an identifier (e.g., a messaging system identifier, email address, or device identifier) indicative of a user of the client device 102 to which the message 400 is addressed.

The contents (e.g., values) of the various components of message 400 may be pointers to locations in tables within which content data values are stored. For example, an image value in the message image payload 406 may be a pointer to (or address of) a location within an image table 312. Similarly, values within the message video payload 408 may point to data stored within a video table 304, values stored within the message augmentation data 412 may point to data stored in an augmentation table 310, values stored within the message story identifier 418 may point to data stored in a story table 314, and values stored within the message sender identifier 422 and the message receiver identifier 424 may point to user records stored within an entity table 306.

### Avatar Fashion Delivery System

FIG. 5 is a block diagram showing an example avatar fashion delivery system 224, according to example examples. The avatar fashion delivery system 224 includes a user selection module 519, a fashion item delivery module 514, a scarcity parameter module 516, and an avatar display module 520. All or some of the components of the avatar fashion delivery system 224 can be implemented by a server. In some cases, some or all of the components of the avatar fashion delivery system 224 can be implemented by the client device 102 or can be distributed across a set of client devices 102 and/or one or more servers.

The avatar fashion delivery system 224 delivers, by a messaging server, a notification to a client device that identifies a fashion item for customizing an avatar of a user. The avatar fashion delivery system 224 causes the notification including the fashion item to be displayed on the client device 102 and receives, by the messaging server, a request from the client device 102 to access the fashion item. The avatar fashion delivery system 224 determines that the request from the client device 102 to access the fashion item has been received prior to expiration of a scarcity parameter of the fashion item and enables the client device 102 to access the fashion item in response to determining that the request from the client device has been received prior to the expiration of the scarcity parameter of the fashion item.

In some examples, the scarcity parameter includes at least one of a time period or a remaining quantity. In some examples, the avatar fashion delivery system 224 determines that the request from the client device 102 to access the fashion item has been received prior to the expiration of the scarcity parameter of the fashion item by determining that a time at which the request has been received is prior to an end of the time period. In some examples, the avatar fashion delivery system 224 determines that the request from the client device 102 to access the fashion item has been received prior to the expiration of the scarcity parameter of the fashion item by determining that the remaining quantity of the fashion item at a time when the request has been received is non-zero.

In some examples, the avatar fashion delivery system 224 displays, in the notification, at least one of the time period or the remaining quantity. In some examples, the avatar fashion delivery system 224 animates a time remaining indicator or quantity indicator, in the notification, as time progresses or as the remaining quantity is reduced. In some examples, the avatar fashion delivery system 224 determines that a user interface of the client device corresponds to an avatar building (construction or generation) feature of a messaging client or a profile feature of the messaging client 104. The avatar fashion delivery system 224 causes the notification to be displayed on the client device 102 in response to determining that the user interface of the client device 102 corresponds to the avatar building feature or the profile feature.

In some examples, the avatar fashion delivery system 224 causes the notification to display a token quantity associated with accessing the fashion item. The avatar fashion delivery system 224 deducts the token quantity from a virtual wallet associated with the client device 102 in response to enabling the client device to access the fashion item.

In some examples, the avatar fashion delivery system 224 prevents another client device 102 from obtaining access to the fashion item after the expiration of the scarcity parameter of the fashion item. In some aspects, the avatar fashion delivery system 224 saves the fashion item to a virtual closet including a plurality of fashion items in response to enabling the client device 102 to access the fashion item. The avatar fashion delivery system 224 causes an avatar to be displayed on the client device 102 including one or more of the fashion items in the virtual closet.

In some examples, the avatar fashion delivery system 224 receives input that deletes the fashion item from the virtual closet. In such cases, the avatar fashion delivery system 224 prevents the fashion item from being available to the client device 102 in response to receiving the input that deletes the fashion item from the virtual closet. In some examples, the avatar fashion delivery system 224 visually distinguishes the fashion item from the plurality of fashion items in the virtual closet.

In some examples, the avatar fashion delivery system 224 causes display of a user interface including the avatar on the client device. The user interface includes a menu including a plurality of avatar customization options. The notification can be presented as an interactive banner among the plurality of avatar options.

In some examples, the avatar fashion delivery system 224 causes the client device 102 to present a preview of the fashion item in response to detecting interaction with the notification. The preview can include a save to virtual closet option. In some examples, the avatar fashion delivery system 224 reduces a remaining quantity for the fashion item in response to enabling the client device to access the fashion item.

In some examples, the avatar fashion delivery system 224 determines that the user of the client device satisfies a criterion. The notification can be delivered in response to determining that the user of the client device satisfies the criterion. In some examples, the criterion includes at least one of a location, demographic, or a subscription status.

In some examples, the avatar fashion delivery system 224 receives input from the client device 102 that adds the fashion item to the avatar. The avatar fashion delivery system 224 shares the avatar with the fashion item with one or more friends of the user on a messaging application.

User selection module 519 obtains information about a scarce fashion item that includes one or more user selection criteria. The user selection criteria can specify geographical locations criteria, demographic criteria, and/or subscription status criteria. The user selection module 519 can select a group of users to which to deliver the scarce fashion item based on the one or more user selection criteria. In some cases, the scarce fashion item is not associated with any user selection criteria and, in such instances, the user selection module 519 delivers the scarce fashion item to all of the users of the messaging server system 108.

For example, the user selection criteria can specify one or more geographical locations that are used as a basis for delivering a scarce fashion item. In such cases, the user selection module 519 accesses a GPS system of the client device 102 for a given user to determine the geographical location of the client device 102. The user selection module 519 computes a radius (e.g., 25 miles) from the geographical location of the client device 102 and determines whether the radius from the geographical location of the client device 102 falls within the geographical locations of the scarce fashion item. In response to determining that the radius from the geographical location of the client device 102 falls within the geographical locations of the scarce fashion item, the user selection module 519 includes the client device 102 among a list of client devices 102 to which the scarce fashion item will be delivered. Otherwise, the client device 102 is excluded from the list. This way, the scarce fashion item can be restricted to being available and delivered to a specific set of geographical locations.

In some examples, the user selection criteria can specify one or more demographics that are used as a basis for delivering a scarce fashion item. In such cases, the user selection module 519 accesses profile information of a user associated with the client device 102 to determine one or more demographics of the user. The user selection module 519 determines whether the demographics stored within the user profile match the demographics associated with the scarce fashion item. In response to determining that the demographics match, the user selection module 519 includes the client device 102 among a list of client devices 102 to which the scarce fashion item will be delivered. Otherwise, the client device 102 is excluded from the list. This way, the scarce fashion item can be restricted to being available and delivered to specific users being associated with a particular set of demographics.

In some examples, the user selection criteria can specify a subscription status that is used as a basis for delivering a scarce fashion item. In such cases, the user selection module 519 accesses account information of a user associated with the client device 102 to determine whether a subscription status of the user is a standard subscription (free account) or premium subscription (e.g., paying account). The user selection module 519 determines whether the subscription status in the account information corresponds to the subscription status associated with the scarce fashion item. In response to determining that the subscription status in the account information corresponds to the subscription status associated with the scarce fashion item (e.g., in response to determining that the user has a premium subscription), the user selection module 519 includes the client device 102 among a list of client devices 102 to which the scarce fashion item will be delivered. Otherwise, the client device 102 is excluded from the list. This way, the scarce fashion item can be restricted to being available and delivered to specific users being associated with a particular subscription status.

The fashion item delivery module 514 receives the list of users from the user selection module 519 and delivers a notification to each messaging client 104 of the users on the list of users. Specifically, the fashion item delivery module 514 can receive a scarce fashion item selection from a third-party entity or sponsor. The scarce fashion item can include or be associated with a target audience, a scarcity parameter (e.g., time and/or limited available quantity), a cost (e.g., minimum quantity of tokens for accessing the scarce fashion item), a title, an image, video or animation, and display attributes and parameters that are used to place the fashion item on a given avatar. The fashion item delivery module 514 can communicate the target audience to the user selection module 519 to obtain the list of users and can communicate the scarcity parameter to the scarcity parameter module 516 to control whether to enable access to the scarce fashion item on a particular client device 102.

The fashion item delivery module 514 can generate a notification that identifies the scarce fashion item. For example, the notification can include a representation of the third-party or sponsor of the scarce fashion item. The notification can include a title and/or type of the fashion item but can exclude a visual depiction of the fashion item. The notification can include a message indicating that the fashion item is scarce and is available only on a limited basis (e.g., based on the scarcity parameter). The notification can then be transmitted to the client device 102 of each user on the list of users.

A given one of the client devices 102 can receive the notification and can present the notification as a pop-up message in the messaging client 104 and/or as a push notification, such as a text message in the normal operating system of the client device 102. In some cases, the notification is presented only in a certain user interface or feature of the messaging client 104, such as an avatar configuration interface or a profile interface. In such cases, the client device 102 can store the notification and can present the notification in response to determining that the particular user interface is currently being accessed. Namely, if the profile interface is being accessed and a notification for the scarce fashion item has previously been received, the client device 102 can present the notification in a dedicated region of the profile interface. In some cases, the client device 102 can access the scarcity parameter of the scarce fashion item and communicate with the scarcity parameter module 516 prior to displaying the notification. Namely, the client device 102 can communicate with the scarcity parameter module 516 to determine whether the scarcity parameter (e.g., a time period or remaining quantity) has expired. In response to determining that the scarcity parameter has not expired, the client device 102 can render the display of the notification in the profile interface. Similarly, the client device 102 can condition rendering display of the notification in an avatar configuration interface on the basis of the scarcity parameter.

The fashion item delivery module 514 receives an indication from the client device 102 that a user has selected (e.g., tapped on) the notification that was being presented by the client device 102. For example, the client device 102 can detect input from the user that selects the notification associated with the scarce fashion item. In response, the client device 102 transmits the indication to the fashion item delivery module 514 indicating that the notification has been selected. The indication can include a timestamp identifying the time at which the selection was made. The fashion item delivery module 514 transmits the timestamp and the indication of the selection to the scarcity parameter module 516.

The scarcity parameter module 516 accesses a scarcity parameter of the scarce fashion item and determines whether the notification was selected prior to expiration of the scarcity parameter. For example, the scarcity parameter module 516 can compare a timestamp to an ending time period of the time period associated with the scarce fashion item. In response to determining that the timestamp corresponds to a time point that precedes the ending time period, the scarcity parameter module 516 enables access to the scarce fashion item to the client device 102 from which the indication of the selection of the notification has been received. In response to determining that the timestamp corresponds to a time point that follows the ending time period, the scarcity parameter module 516 prevents access to the scarce fashion item to the client device 102 from which the indication of the selection of the notification has been received.

As another example, the scarcity parameter module 516 can access a remaining quantity associated with the scarce fashion item. The scarcity parameter module 516 can determine if the remaining quantity is non-zero. In response to determining that the remaining quantity is non-zero, the scarcity parameter module 516 can deduct or decrement the remaining quantity by one value and enable access to the scarce fashion item to the client device 102 from which the indication of the selection of the notification has been received. In response to determining that the remaining quantity is zero, the scarcity parameter module 516 can prevent access to the scarce fashion item to the client device 102 from which the indication of the selection of the notification has been received.

In some cases, in response to determining that access to the scarce fashion item is enabled for a particular client device 102, the scarcity parameter module 516 communicates an identity of the scarce fashion item and an identity of the particular client device 102 (or user associated with the particular client device 102) to the avatar display module 520. The avatar display module 520 can unlock a preview of the scarce fashion item for display on the particular client device 102. The client device 102 then presents an image or animation corresponding to the scarce fashion item in the user interface, such as in a full screen display or a portion of the screen. The client device 102 can receive a request from the user to add or store the scarce fashion item to a virtual closet associated with the user. In response, the client device 102 communicates this request to the avatar display module 520. The avatar display module 520 can then update a virtual closet associated with an account of the user to add the scarce fashion item to the virtual closet among one or more other fashion items. Each fashion item in the virtual closet can be used to configure or customize an avatar representing the user.

In some examples, the scarcity parameter module 516 can determine whether the scarce fashion item is associated with a cost or minimum token quantity. In such cases, the client device 102 can present the cost or minimum token quantity in the preview of the scarce fashion item. In response to receiving the request to add or store the scarce fashion item to a virtual closet associated with the user, the client device 102 communicates the request to the avatar fashion delivery system 224 which then accesses a virtual wallet associated with the user of the client device 102. The avatar fashion delivery system 224 determines whether the virtual wallet includes more tokens than the minimum token quantity. In response to determining that the virtual wallet includes more tokens than the minimum token quantity, the avatar fashion delivery system 224 deducts the cost or minimum token quantity from the virtual wallet and then instructs the avatar display module 520 to add or store the scarce fashion item in the virtual closet for the user.

In some examples, the scarcity parameter module 516 can determine whether the scarce fashion item is associated with an action, puzzle, or activity. In such cases, the client device 102 can present the action, puzzle, or activity in the preview of the scarce fashion item. In response to receiving the request to add or store the scarce fashion item to a virtual closet associated with the user, the client device 102 instructs the user to perform the action, puzzle, or activity. In response to determining that the action, puzzle, or activity has successfully been performed, the avatar display module 520 is instructed to add or store the scarce fashion item in the virtual closet for the user.

In some examples, the scarce fashion item is visually distinguished from other fashion items in the virtual closet when the virtual closet is accessed or displayed on the client device 102. For example, a colorful border is placed around the scarce fashion item to indicate that the scarce fashion item was associated with a limited quantity, time period or distribution or other scarcity parameter and was added to the virtual closet prior to expiration of the scarcity parameter. Other fashion items that are not scarce fashion items can exclude the colorful border. The visual distinguishing attribute of the scarce fashion item to distinguish the scarce fashion item from other items in the virtual closet can be configured by the user, the developer of the scarce fashion item, or another third party.

Avatar display module 520 retrieves an avatar for the user associated with the client device 102. The avatar display module 520 adjusts the avatar for the user based on a combination of avatar customization, such as one or more scarce fashion items available in a virtual closet for a user. The avatar display module 520 allows the user to preview how the avatar will look with the scarce fashion item prior to receiving a request to purchase or add the scarce fashion item to the virtual closet of the user.

In some examples, the client device 102 can prevent displaying the notification in one of the user interfaces (e.g., profile or avatar customization interface) in response to determining that the notification has previously been selected by the user. This way, the notification is only presented while the scarce fashion item is still available and if the user has not previously selected the notification to access the scarce fashion item.

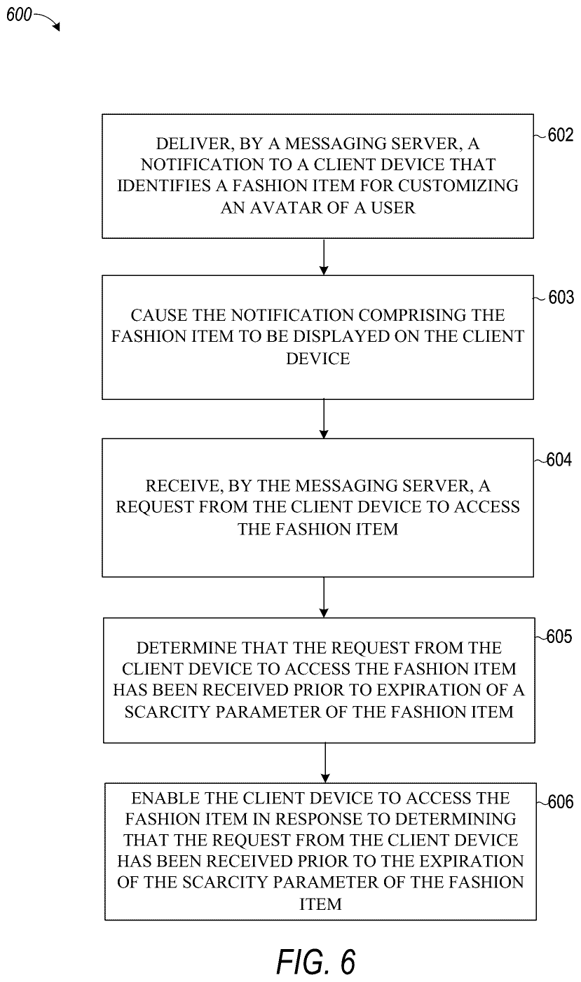

FIG. 6 is a flowchart illustrating example operations of the avatar fashion delivery system 224 in performing process 600, according to some examples. The process 600 may be embodied in computer-readable instructions for execution by one or more processors such that the operations of the process 600 may be performed in part or in whole by the functional components of the messaging server system 108; accordingly, the process 600 is described below by way of example with reference thereto. However, in other embodiments, at least some of the operations of the process 600 may be deployed on various other hardware configurations. The process 600 is therefore not intended to be limited to the messaging server system 108 and can be implemented in whole, or in part, by any other component. Some or all of the operations of process 600 can be in parallel, out of order, or entirely omitted.

At operation 602, the avatar fashion delivery system 224 delivers, by a messaging server, a notification to a client device that identifies a fashion item for customizing an avatar of a user, as discussed above and below.

At operation 603, the avatar fashion delivery system 224 causes the notification comprising the fashion item to be displayed on the client device, as discussed above and below.

At operation 604, the avatar fashion delivery system 224 receives, by the messaging server, a request from the client device to access the fashion item, as discussed above and below.

At operation 605, the avatar fashion delivery system 224 determines that the request from the client device to access the fashion item has been received prior to expiration of a scarcity parameter of the fashion item, as discussed above and below.

At operation 606, the avatar fashion delivery system 224 enables the client device to access the fashion item in response to determining that the request from the client device has been received prior to the expiration of the scarcity parameter of the fashion item, as discussed above and below.

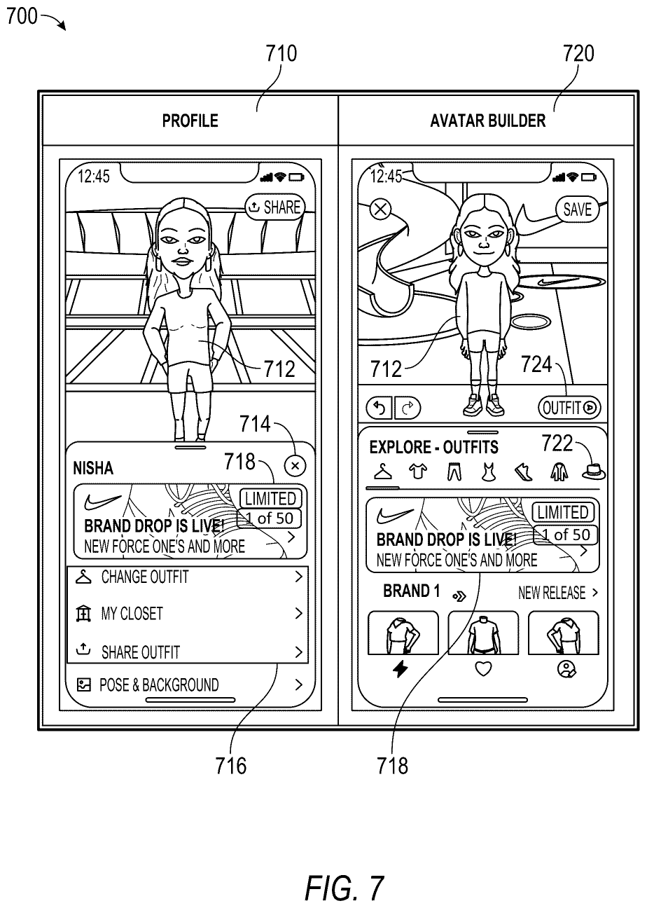

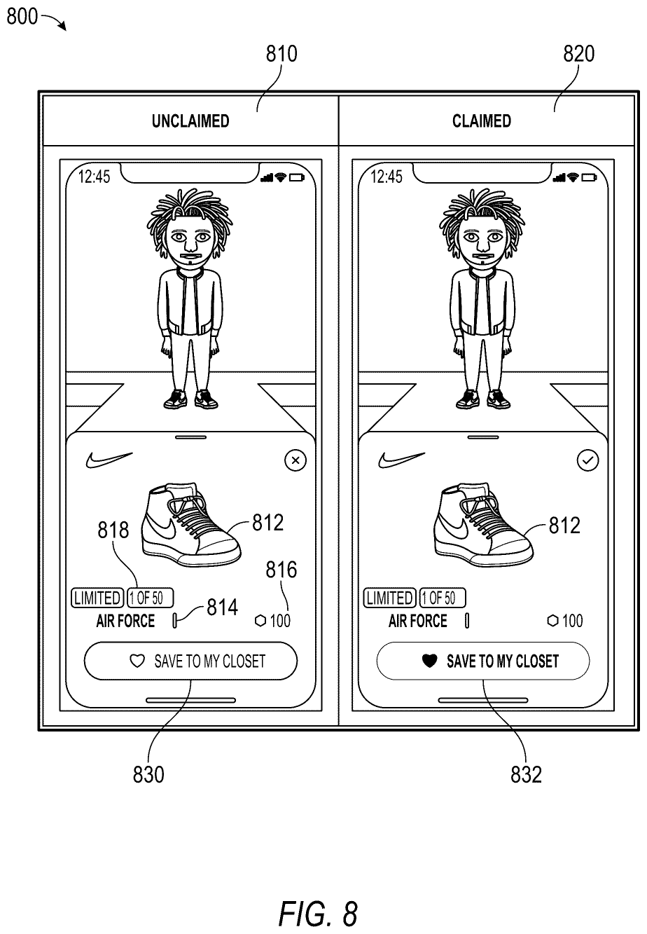

FIGS. 7-8 show illustrative inputs and outputs of the avatar fashion delivery system 224, according to some examples. As shown in FIG. 7, a set of user interfaces 700 of a messaging client 104 can include a notification about a scarce fashion item. For example, the client device 102 can receive a request from a user to access a profile user interface 710. In response, the client device 102 can present a current avatar 712 for the user along with various profile features in a profile menu 714. The profile menu 714 can include one or more avatar customization options 716 including a change outfit option, a virtual closet option to access a virtual closet for the user that includes one or more fashion items, and a share outfit option. The notification can include an indication of the scarcity parameter (e.g., a time remaining, cost or price, and/or quantity remaining indicator) which can be animated over time to indicate to the user the limited basis of the scarce fashion item.

The client device 102, in response to accessing the profile user interface 710, can access a local storage to determine if a notification associated with a scarce fashion item is currently active. Namely, the client device 102 can access a notification and communicate with the avatar fashion delivery system 224 to determine if the notification was previously selected and/or if the scarcity parameter of the notification has already expired. In response to determining that the notification was not previously selected and that the scarcity parameter of the notification has not yet expired, the client device 102 presents the notification 718 in the profile menu 714.

In some examples, the client device 102 can receive a request from a user to access an avatar builder interface 720. In response, the client device 102 can present the current avatar 712 for the user along with various avatar customization options 722. The various avatar customization options 722 can include an option to access a virtual closet, an option to add a specific type of garment (e.g., a hat, shirt, shoes, and so forth). In some cases, the various avatar customization options 722 include an option to access a list of scarce fashion items. In response to receiving the user selection of the option to access the list of scarce fashion items, the client device 102 retrieves one or more previously enabled scarce fashion items (e.g., fashion items that were selected and enabled for the user of the client device 102 prior to expiration of the corresponding expiration parameters). The client device 102 can allow the user to select one or more of the scarce fashion items from the list of scarce fashion items to customize the look and feel of the current avatar 712.

The client device 102, in response to accessing the avatar builder interface 720, can access a local storage to determine if a notification associated with a scarce fashion item is currently active. Namely, the client device 102 can access a notification and communicate with the avatar fashion delivery system 224 to determine if the notification was previously selected and/or if the scarcity parameter of the notification has already expired. In response to determining that the notification was not previously selected and that the scarcity parameter of the notification has not yet expired, the client device 102 presents the notification 718 among (underneath or on top of) the various avatar customization options 722.

The notification 718 includes an indication that the scarce fashion item is limited (e.g., by time and/or quantity) and can include a title of the fashion item and/or identity of the sponsor or creator of the scarce fashion item. In some cases, the notification 718 can animate a remaining time to select the notification 718 and/or a remaining quantity of the scarce fashion item over time or as time progresses. For example, the notification 718 can include a countdown timer to show the user how long is left for the user to claim or request to access the corresponding scarce fashion item.

In some examples, the client device 102 receives input that selects the notification 718. In response, the client device 102 presents one of the user interfaces 800, shown in FIG. 8. Namely, the client device 102 initially presents the user interface 810, which includes a preview 812 of the scarce fashion item in the unclaimed state. The unclaimed state is a state in which the scarce fashion item has not yet been saved, purchased, and/or added to a virtual closet of the user.

The user interface 810 includes a current representation of the avatar and can optionally include a depiction of the scarce fashion item on the avatar as the preview. The preview 812 can be displayed in full screen or in a partial screen arrangement. The user interface 810 includes an indication 818 of the scarcity parameter (e.g., a time remaining, cost or price, and/or quantity remaining indicator) which can be animated over time to indicate to the user the limited basis of the scarce fashion item. The user interface 810 includes a title 814 of the scarce fashion item. The user interface 810 includes a minimum token quantity 816 for purchasing or enabling access to the scarce fashion item if a cost is associated with the scarce fashion item.

The user interface 810 includes a save to virtual closet option 830 (or claim and wear option). The virtual closet option 830 can be selected to purchase and/or request that the scarce fashion item be added to the virtual closet or account of the user. In response to receiving selection of the virtual closet option 830, the client device 102 communicates a timestamp and identity of the user to the avatar fashion delivery system 224. The avatar fashion delivery system 224 can determine whether the virtual closet option 830 was selected prior to expiration of the scarcity parameter. In response to determining that the virtual closet option 830 was selected prior to expiration of the scarcity parameter, the avatar fashion delivery system 224 deducts tokens from a virtual wallet of the user (if a cost is associated with the scarce fashion item) and updates the scarcity parameter and adds the scarce fashion item to the virtual closet or account of the user.

The avatar fashion delivery system 224 sends a message back to the client device 102 indicating whether the scarce fashion item has been successfully claimed (e.g., enabled for access). In such cases, the client device 102 presents the user interface 820 in which an indicator 832 is displayed to inform the user that the scarce fashion item has been added to the virtual closet.

In some cases, a user can share the scarce fashion item and/or notification with another user or friend. In response to receiving a request from the user to share the scarce fashion item, the avatar fashion delivery system 224 transmits a notification to the recipient user or friend allowing the recipient user or friend to also claim access to the scarce fashion item. The avatar fashion delivery system 224 allows the recipient user or friend to obtain access to and have the same scarce fashion item enabled for use if the recipient user or friend selects the option (e.g., a save to virtual closet option 830) before the scarcity parameter expires.

### Machine Architecture

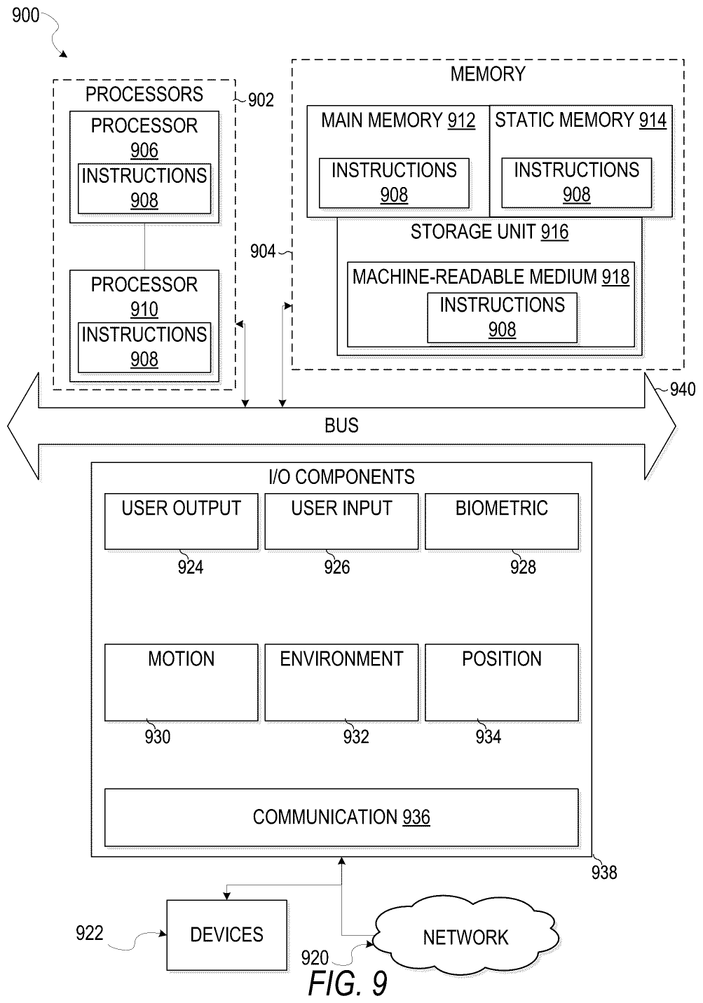

FIG. 9 is a diagrammatic representation of the machine 900 within which instructions 908 (e.g., software, a program, an application, an applet, an app, or other executable code) for causing the machine 900 to perform any one or more of the methodologies discussed herein may be executed. For example, the instructions 908 may cause the machine 900 to execute any one or more of the methods described herein. The instructions 908 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines that individually or jointly execute the instructions 908 to perform any one or more of the methodologies discussed herein. The machine 900, for example, may comprise the client device 102 or any one of a number of server devices forming part of the messaging server system 108. In some examples, the machine 900 may also comprise both client and server systems, with certain operations of a particular method or algorithm being performed on the server-side and with certain operations of the particular method or algorithm being performed on the client-side.

The machine 900 may include processors 902, memory 904, and input/output (I/O) components 938, which may be configured to communicate with each other via a bus 940. In an example, the processors 902 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 906 and a processor 910 that execute the instructions 908. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single-core, a single processor with multiple cores (e.g., a multi-core processor), multiple processors with a single core, multiple processors with multiples cores, or any combination thereof.

The memory 904 includes a main memory 912, a static memory 914, and a storage unit 916, all accessible to the processors 902 via the bus 940. The main memory 904, the static memory 914, and the storage unit 916 store the instructions 908 embodying any one or more of the methodologies or functions described herein. The instructions 908 may also reside, completely or partially, within the main memory 912, within the static memory 914, within a machine-readable medium within the storage unit 916, within at least one of the processors 902 (e.g., within the processor's cache memory), or any suitable combination thereof, during execution thereof by the machine 900.

The I/O components 938 may include a wide variety of components to receive input, provide output, produce output, transmit information, exchange information, capture measurements, and so on. The specific I/O components 938 that are included in a particular machine will depend on the type of machine. For example, portable machines such as mobile phones may include a touch input device or other such input mechanisms, while a headless server machine will likely not include such a touch input device. It will be appreciated that the I/O components 938 may include many other components that are not shown in FIG. 9. In various examples, the I/O components 938 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 938 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 930 include acceleration sensor components (e.g., accelerometer), gravitation sensor components, rotation sensor components (e.g., gyroscope).

The environmental components 932 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 102 may have a camera system comprising, for example, front cameras on a front surface of the client device 102 and rear cameras on a rear surface of the client device 102. The front cameras may, for example, be used to capture still images and video of a user of the client device 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 102 may also include a 360° camera for capturing 360° photographs and videos.

Further, the camera system of a client device 102 may include dual rear cameras (e.g., a primary camera as well as a depth-sensing camera), or even triple, quad or penta rear camera configurations on the front and rear sides of the client device 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 938 further include communication components 936 operable to couple the machine 900 to a network 920 or devices 922 via respective coupling or connections. For example, the communication components 936 may include a network interface component or another suitable device to interface with the network 920. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 922 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 912, static memory 914, and memory of the processors 902) and storage unit 916 may store one or more sets of instructions and data structures (e.g., software) embodying or used by any one or more of the methodologies or functions described herein. These instructions (e.g., the instructions 908), when executed by processors 902, cause various operations to implement the disclosed examples.

The instructions 908 may be transmitted or received over the network 920, using a transmission medium, via a network interface device (e.g., a network interface component included in the communication components 936) and using any one of several well-known transfer protocols (e.g., hypertext transfer protocol (HTTP)). Similarly, the instructions 908 may be transmitted or received using a transmission medium via a coupling (e.g., a peer-to-peer coupling) to the devices 922.

### Software Architecture

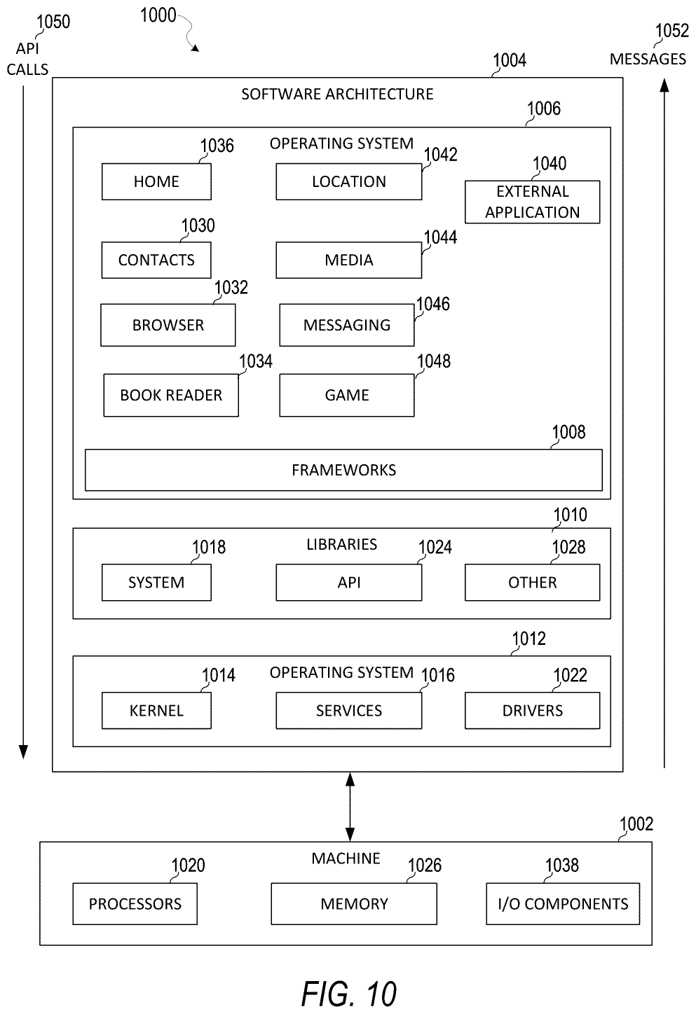

FIG. 10 is a block diagram 1000 illustrating a software architecture 1004, which can be installed on any one or more of the devices described herein. The software architecture 1004 is supported by hardware such as a machine 1002 that includes processors 1020, memory 1026, and I/O components 1038. In this example, the software architecture 1004 can be conceptualized as a stack of layers, where each layer provides a particular functionality. The software architecture 1004 includes layers such as an operating system 1012, libraries 1010, frameworks 1008, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, processor management (e.g., scheduling), component management, networking, and security settings, among other functionality. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1010 provide a common low-level infrastructure used by the applications 1006. The libraries 1010 can include system libraries 1018 (e.g., C standard library) that provide functions such as memory allocation functions, string manipulation functions, mathematic functions, and the like. In addition, the libraries 1010 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1010 can also include a wide variety of other libraries 1028 to provide many other APIs to the applications 1006.

The frameworks 1008 provide a common high-level infrastructure that is used by the applications 1006. For example, the frameworks 1008 provide various graphical user interface (GUI) functions, high-level resource management, and high-level location services. The frameworks 1008 can provide a broad spectrum of other APIs that can be used by the applications 1006, some of which may be specific to a particular operating system or platform.

In an example, the applications 1006 may include a home application 1036, a contacts application 1030, a browser application 1032, a book reader application 1034, a location application 1042, a media application 1044, a messaging application 1046, a game application 1048, and a broad assortment of other applications such as an external application 1040. The applications 1006 are programs that execute functions defined in the programs. Various programming languages can be employed to create one or more of the applications 1006, structured in a variety of manners, such as object-oriented programming languages (e.g., Objective-C, Java, or C++) or procedural programming languages (e.g., C or assembly language). In a specific example, the external application 1040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the external application 1040 can invoke the API calls 1050 provided by the operating system 1012 to facilitate functionality described herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions.

Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 902 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

What is claimed is:

1. A method comprising:
receiving a request from a device to access an object;
determining that the request from the device to access the object has been received prior to expiration of a scarcity parameter of the object, access to the object being disabled and the scarcity parameter expiring in response to determining that a number of users corresponding to a remaining quantity associated with the object have added the object to respective profiles of the users; and
enabling the device to access the object in response to determining that the request from the device has been received prior to the expiration of the scarcity parameter of the object.

2. The method of claim 1, further comprising presenting a notification on the device excluding a visual depiction of the object, the notification comprising a title and type associated with the object.

3. The method of claim 2, further comprising unlocking a preview of the object in response to determining that access to the object has been enabled, the preview comprising the visual depiction which was excluded from the notification.

4. The method of claim 2, wherein determining that the request from the device to access the object has been received prior to the expiration of the scarcity parameter of the object comprises determining that a number of instances of the object available to be requested to be added to an individual profile of the user at a time when the request has been received is non-zero.

5. The method of claim 2, further comprising:
displaying in the notification the remaining quantity.

6. The method of claim 5, further comprising animating a time remaining indicator or quantity indicator, in the notification, as time progresses or as the remaining quantity is reduced.

7. The method of claim 1, further comprising:
storing a notification on the device;
receiving a request to access a user interface of the device corresponding to an avatar building feature or profile feature;
in response to receiving the request to access the user interface, determining whether the scarcity parameter has expired; and
in response to determining that the scarcity parameter has not yet expired when the request to access the user interface is received, retrieving the notification from storage on the device and causing the notification to be displayed on the user interface of the device corresponding to the avatar building feature or the profile feature, the notification being conditioned for display on a basis of the scarcity parameter.

8. The method of claim 1, further comprising:
causing a notification to display a token quantity associated with accessing the object; and
deducting the token quantity from a virtual wallet associated with the device in response to enabling the device to access the object.

9. The method of claim 1, further comprising:
preventing another device from obtaining access to the object after the expiration of the scarcity parameter of the object.

10. The method of claim 1, further comprising:
saving the object to a virtual closet comprising a plurality of objects in response to enabling the device to access the object; and
causing an avatar to be displayed on the device comprising one or more of the objects in the virtual closet.

11. The method of claim 10, further comprising:
receiving input that deletes the object from the virtual closet; and
preventing the object from being available to the device in response to receiving the input that deletes the object from the virtual closet.

12. The method of claim 10, further comprising visually distinguishing the object from the plurality of objects in the virtual closet.

13. The method of claim 1, further comprising:
causing display of a user interface comprising an avatar on the device, wherein the user interface includes a menu comprising a plurality of avatar customization options, and wherein a notification is presented as an interactive banner among the plurality of avatar options.

14. The method of claim 1, further comprising:
causing the device to present a preview of the object in response to detecting interaction with a notification, the preview comprising a save to virtual closet option.

15. The method of claim 1, further comprising:
presenting a puzzle or activity;
in response to receiving a request to add the object to a profile, instructing the user to perform the puzzle or activity; and
in response to determining that the puzzle or activity has successfully been performed prior to the expiration of the scarcity parameter of the object, adding the object to the profile of the user.

16. The method of claim 1, further comprising:
determining that the user of the device satisfies a criterion, wherein a notification is delivered in response to determining that the user of the device satisfies the criterion.

17. The method of claim 16, wherein the criterion comprises at least one of a location or a subscription status.

18. The method of claim 1, further comprising:
receiving input from the device that adds the object to an avatar; and
sharing the avatar with the object with one or more friends of the user on a messaging application.

19. A system comprising:
at least one processor programmed to perform operations comprising:
receiving a request from a device to access an object;
determining that the request from the device to access the object has been received prior to expiration of a scarcity parameter of the object, access to the object being disabled and the scarcity parameter expiring in response to determining that a number of users corresponding to a remaining quantity associated with the object have added the object to respective profiles of the users; and
enabling the device to access the object in response to determining that the request from the device has been received prior to the expiration of the scarcity parameter of the object.

20. A non-transitory machine-readable storage medium that includes instructions that, when executed by one or more processors of a machine, cause the machine to perform operations comprising:
receiving a request from a device to access an object;
determining that the request from the device to access the object has been received prior to expiration of a scarcity parameter of the object, access to the object being disabled and the scarcity parameter expiring in response to determining that a number of users corresponding to a remaining quantity associated with the object have added the object to respective profiles of the users; and
enabling the device to access the object in response to determining that the request from the device has been received prior to the expiration of the scarcity parameter of the object.
